(19) United States
(12) Patent Application Publication
(10) Pub. No.: US 2012/0052302 A1
(43) Pub. Date: Mar. 1, 2012

(54) METHOD OF STRENGTHENING EDGE OF GLASS ARTICLE

(76) Inventors: Joseph M. Matusick, Corning, NY (US); Michael T. Preston, Elmira, NY (US); Robert A. Schaut, Painted Post, NY (US); Daniel A. Sternquist, Horseheads, NY (US); Heather Debra Boek, Corning, NY (US); Mark Owen Weller, Painted Post, NY (US)

(21) Appl. No.: 12/862,096

(22) Filed: Aug. 24, 2010

(51) Int. Cl. B32B 33/00; C03C 15/02; B05D 3/08; C03C 15/00; B32B 17/00

(52) U.S. Cl. 428/410; 65/31; 427/309; 216/97

(57) ABSTRACT

A method of strengthening an edge of a glass article while maintaining the optical clarity of the major surfaces or protecting layers or structures deposited on the surfaces of the article. A protective coating or film of a polymer or polymer resin is applied to at least one surface of the glass article. The surface may either be melt-derived or polished, and/or chemically or thermally strengthened. The edge is etched with an etchant to reduce the size and number of flaws on the edge, thereby strengthening the edge. A glass article having an edge strengthened by the method is also provided.

### BACKGROUND

The disclosure relates to methods of strengthening an edge of a glass article. More particularly, the disclosure relates to methods of strengthening a glass article by decreasing the number and size of flaws on the edge of the article. Even more particularly, the disclosure relates to protecting major surfaces of the glass article while strengthening the edge.

Acid etching or fortification has been widely used to increase the strength of glass surfaces by modifying the shape and size of surface flaws, and generally applied to all surfaces of a glass article, particularly for those articles that have not been strengthened by another method. Handling these surfaces after acid etching can induce flaws that lead to a reduction in strength. Etching of all glass surfaces of a flat glass article can lead to optical distortions caused by non-uniform etching and changes in part thickness due to removal of material by the etching process.

Optical distortions are readily observable in thin flat glass articles and can result from fluctuations in part thickness. These distortions can be caused by unevenly dispersed organic residue or inhomogeneities in the glass itself or in the etchant. Surface roughness caused by the etching process also reduces the optical clarity of a flat surface, and is manifested as haze or diffuse scattering. Many applications demand tight control of part thickness. However, acid etching of an entire part reduces the part thickness and would require thickness compensation after etching to meet desired tolerances.

### SUMMARY

A method of strengthening an edge of a glass article and a glass article having an edge strengthened by the method are provided. The method maintains the optical clarity of the major surfaces of the article and/or protects layers or structures deposited on the surface. A protective coating or film comprising a polymer or polymer resin is applied to at least a portion of a surface of the glass article. The surface may either be melt-derived or polished and, in addition, chemically or thermally strengthened. The edge is etched with an etchant to reduce the size and number of flaws on the edge, thereby strengthening the edge.

Accordingly, one aspect of the disclosure is to provide a method of strengthening an edge of a glass article. The method comprises the steps of: providing a glass article having a surface; protecting at least a portion of the surface; and reducing the dimensions of each of a plurality of flaws on an edge adjacent to the protected surface of the glass article, wherein reducing the dimensions of the flaws strengthens the edge.

A second aspect of the disclosure is to provide a glass article. The glass article has a surface under compressive stress and an edge adjacent to the surface, wherein at least a portion of the edge is not under compressive stress. The edge has a predetermined profile and is etched. The etched edge has an edge strength of at least 250 MPa.

These and other aspects, advantages, and salient features will become apparent from the following detailed description, the accompanying drawings, and the appended claims.

### BRIEF DESCRIPTION OF THE DRAWINGS

FIG. 1a is a schematic representation of a first method of strengthening an edge of a glass article;

FIG. 1b is a schematic representation of a second method of strengthening an edge of a glass article;

FIG. 2 is a schematic cross-section of edges having chamfered, rounded (bullnose), and as-formed profiles;

FIG. 3 is a schematic cross-section of a glass article having a strengthened edge;

FIG. 4 is a plot of Weibull edge strength distributions for glass samples having surfaces that were strengthened using different ion exchange conditions;

FIG. 5 is a plot of Weibull edge strength distributions for glass samples having surfaces protected by different adhesive-backed LDPE-based film types;

FIG. 6 is a plot of Weibull edge strength distributions for glass samples protected by adhesive-backed LDPE-based film either before edging or after edging;

FIG. 7 is a plot of Weibull edge strength distributions for glass samples having edges that were edged using different edging techniques;

FIG. 8 is a plot of Weibull edge strength distributions for glass samples having edges that were etched for different etch times;

FIG. 9 is a plot of Weibull edge strength distributions for glass samples having edges that were etched for 32 minutes in either a static etch bath or an agitated etch bath; and

FIG. 10 is a plot of Weibull edge strength distributions for glass samples having edges that were etched for 128 minutes in either a static etch bath or an agitated etch bath.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” “an,” and the corresponding definite article “the” means “at least one” or “one or more,” unless specified otherwise.

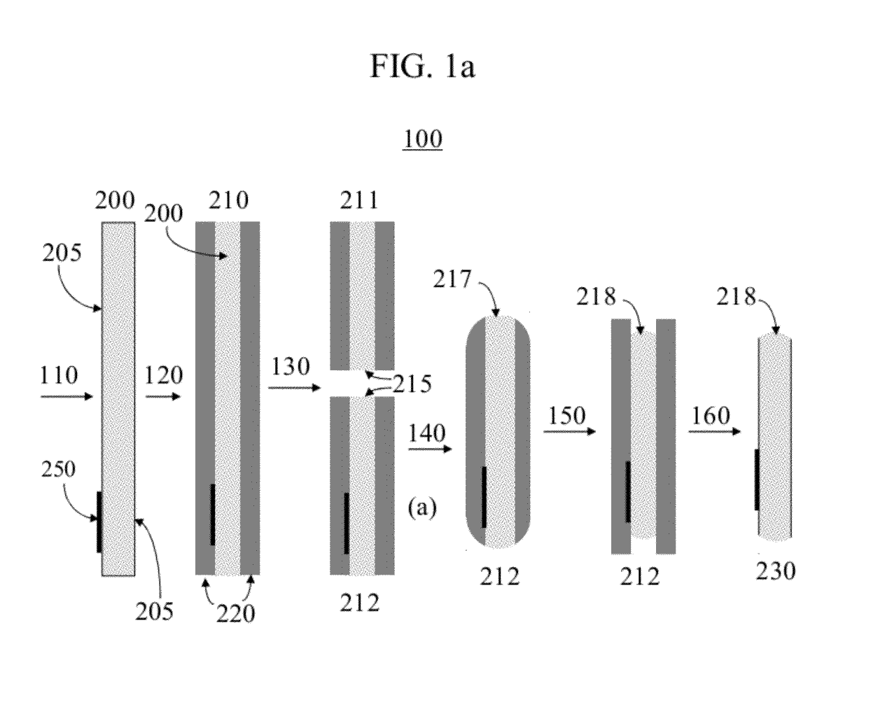

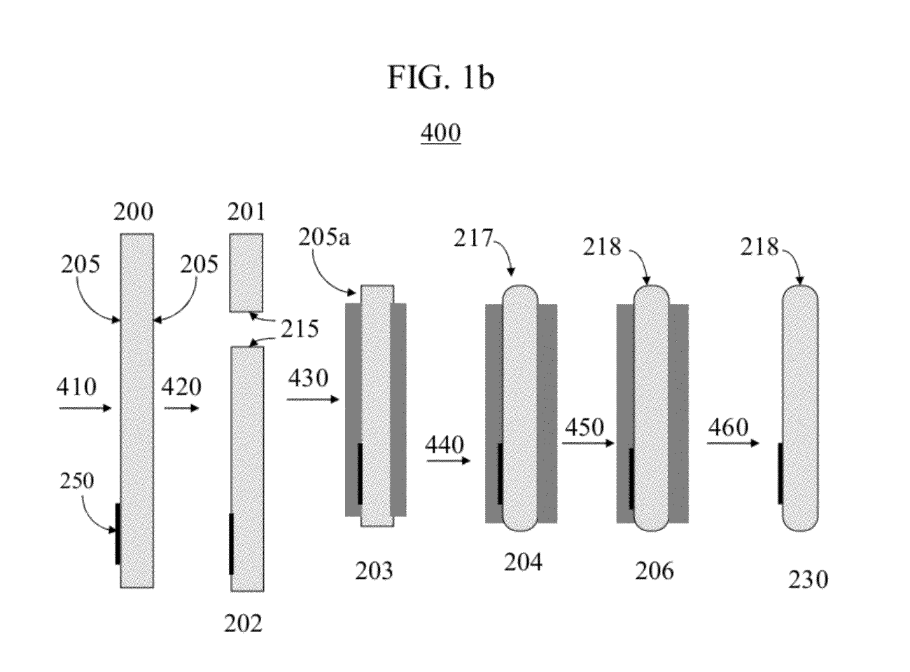

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

A method of strengthening an edge of a glass article is provided. The method comprises providing a glass article having a surface, protecting at least a portion of the surface, and strengthening the edge by reducing the dimensions of each of a plurality of flaws on the edge. Although only one surface may be described herein, it is understood that, unless otherwise specified, the method described herein is applicable to one or more surfaces of a glass article.

One embodiment of the method is schematically shown in FIG. 1a. In the first step 110 of method 100, the glass article 200 having surface 205 is first provided. In a planar sheet, opposing major surfaces 205 of the glass article 200 are equivalent to each other and have the greatest surface areas of all surfaces, including edges, of the article. In one embodiment, surface 205 is a melt-derived surface. Such melt-derived surfaces are substantially (i.e., largely, mostly, or to a considerable degree) flaw-free and can be formed by down-draw techniques such as those slot-draw and fusion-draw processes that are known in the art. Alternatively, surface (or surfaces) 205 can be formed by float processes or the like.

Down-draw processes produce melt-derived surfaces 205 that are relatively pristine. Because the strength of the glass surface is controlled by the amount and size of surface flaws, a pristine surface that has had minimal contact with external elements and has a higher initial strength. Down-drawn glass may be drawn to a thickness of less than about 2 mm. In addition, down-drawn glass has a very flat, smooth surface that can be used in its final application without costly grinding and polishing.

The fusion draw process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank. These outside surfaces extend down and inwardly so that they join at an edge below the drawing tank. The two flowing glass surfaces join at this edge to fuse and form a single flowing sheet. The fusion draw method offers the advantage that, since the two glass films flowing over the channel fuse together, neither outside surface of the resulting glass sheet comes in contact with any part of the apparatus. Thus, the surface properties of the glass sheet are not affected by such contact.

The slot draw method is distinct from the fusion draw method. Here the molten raw material glass is provided to a drawing tank. The bottom of the drawing tank has an open slot with a nozzle that extends the length of the slot. The molten glass flows through the slot/nozzle and is drawn downward as a continuous sheet therethrough and into an annealing region. Compared to the fusion draw process, the slot draw process provides a thinner sheet, as only a single sheet is drawn through the slot, rather than two sheets being fused together, as in the fusion down-draw process.

In other embodiments, however, surface 205 is a polished surface having a layer that is under a compressive stress of at least 200 MPa and having flaws averaging less than 10 μm in size. Here, surface 205 is polished prior to strengthening by chemical means such as, for example, ion exchange, or by thermal tempering.

In some embodiments, glass article 200 is or comprises a soda lime glass, an alkali aluminosilicate glass, or an alkali aluminoborosilicate glass. In one embodiment, the alkali aluminosilicate glass comprises alumina, at least one alkali metal and, in some embodiments, at least 50 mol %, SiO₂, in other embodiments, at least 58 mol %, and in still other embodiments, at least 60 mol % SiO₂, wherein the ratio

$$\frac{{Al}_{2} {O}_{3} ( mol \% ) + {B}_{2} {O}_{3} ( mol \% )}{\sum modifiers ( mol \% )} > 1 ,$$

where the modifiers are alkali metal oxides. This glass, in particular embodiments, comprises, consists essentially of, or consists of: 58-72 mol % SiO₂; 9-17 mol % Al₂O₃; 2-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum modifiers ( mol \% )} > 1 ,$$

where the modifiers are alkali metal oxides. In some embodiments, the modifiers further include alkaline earth oxides. In another embodiment, the alkali aluminosilicate glass comprises, consists essentially of, or consists of: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In yet another embodiment, the alkali aluminosilicate glass substrate comprises, consists essentially of, or consists of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

The alkali aluminosilicate glass is, in some embodiments, substantially free of lithium, whereas in other embodiments, the alkali aluminosilicate glass is substantially free of at least one of arsenic, antimony, and barium. In some embodiments, the alkali aluminosilicate glass has a liquidus viscosity of at least 135 kpoise.

In some embodiments, surface 205 of glass article 200 is either chemically or thermally strengthened. Such chemical strengthening can be accomplished by ion exchange. In this process, ions in the surface layer of the glass are replaced by—or exchanged with—larger ions having the same valence or oxidation state as the ions present in the glass. Ions in the surface layer of the glass and the larger ions are typically monovalent metal cations such as, but not limited to, Li⁺, Na⁺, K⁺, Rb⁺, Cs⁺, Ag⁺, Tl⁺, Cu⁺, and the like.

The exchange of metal cations is typically carried out in a molten salt bath, with larger cations from the bath replacing smaller cations within the glass. Ion exchange is limited to a region extending from the surface 205 of glass article 200 to a depth (depth of layer) below surface 205. By way of example, ion exchange of alkali metal-containing glasses can be achieved by immersing the glass in at least one molten salt bath containing a salt such as, but not limited to, nitrates, sulfates, and chlorides of the larger alkali metal ion. The temperature of such molten salt baths is typically in a range from about 380° C. up to about 450° C., with immersion times ranging up to about 16 hours. However, temperatures and immersion times that are different from those described herein can also be used. The replacement or exchange of smaller cations within the glass with larger cations creates a compressive stress in a region extending from surface 205 of glass article 200 to the depth of layer. The compressive stress near surface 205 gives rise to a central tension in an inner or central region of the glass article 200 so as to balance forces within the glass. In those embodiments where the glass is a soda lime glass, the compressive stress is at least 500 MPa and the depth of layer is at least about 13 μm. In those embodiments where the glass is an alkali aluminosilicate glass or an alkali aluminoborosilicate glass, the compressive stress is at least about 600 MPa and the depth of layer is at least about 20 μm and, in some embodiments, in a range from about 20 μm up to about 35 μm.

In some embodiments, glass article 200 further includes at least one electrically active layer 250 disposed on surface 205. Such electrically active layers include those layers comprising dielectric or conductive materials (e.g., indium tin oxide, tin oxide, or the like) used in the manufacture of touch screens, panels, or displays.

In the next step 120 of method 100, the surfaces 205 of the glass article are protected by applying a protective coating 220 to at least a portion of each of surfaces 205. The protective coating 220 can be applied directly after formation of surface 205—e.g., after formation of a melt-derived surface by down-draw methods described herein—so as to protect the surface 205 (and any electrically active layers 250 disposed thereon) from damage during handling. In other embodiments, protective coating 220 is applied after surface 205 is strengthened or otherwise treated or processed. Surface 205 can, for example, be first polished and subsequently strengthened before protective coating 220 is applied. Alternatively, electrically active layer 250 can be applied to surface 205 before application of protective coating 220 and then covered by protective coating 220.

In some embodiments, the protective coating 220 is a polymeric coating that is applied using those coating means known in the art including, but not limited to, spray coating, dip coating, and spin-coating. Such coatings can comprise polymeric precursors that are applied to surface 205 and subsequently cured or dried after deposition. In other embodiments, the protective coating 220 is applied to surface 205 as a free-standing polymeric film. The polymeric film can include an adhesive material disposed on one surface of the film. Here the polymeric film is applied to at least a portion of the surface 205 of glass article 100 by contacting the adhesive material with that portion of surface 205. Such adhesive-backed polymeric films are removable by peeling and can be removed from surface 205 without damage to surface or any coatings or layers (e.g., electrically active layer 250) that are disposed on surface 205. Non-limiting examples of such films include commercially available adhesive-backed low density polyethylene (LDPE)-based films having thicknesses ranging from about 50 μm up to about 100 μm.

The actual choice of material that is used to protect the surface of the glass article can depend on the stiffness of the protective coating during machining or finishing (which can comprises at least one of grinding, lapping, and polishing), the chemical durability of the protective coating 220 with respect to strong acids, and the ease of removal of the protective coating 220. Non-limiting examples of acid-resistant polymeric coatings and films for use as protective coating 220 include polytetrafluoroethylene (PTFE; e.g., TEFLON™), polymethylmethacrylate (PMMA), high density polyethylene (HDPE), low density polyethylene (LDPE), polyvinyl chloride (PVC), polymethyl pentene (PMP), and the like. Other polymers that react only slightly with acids and still retain some measure of functionality may also be used. Such polymeric materials include acrylonitrile/butadiene/styrenes (ABS), polycarbonates (PC), polypropylenes (PP), polystyrenes (PS), and the like. The thickness of the protective coating 220 is sufficient to protect the surface 205 of the glass article from attack by an etchant such as, for example, an acidic etchant. In some embodiments, the protective coating 220 has a thickness in a range from about 5 μm up to about 250 μm.

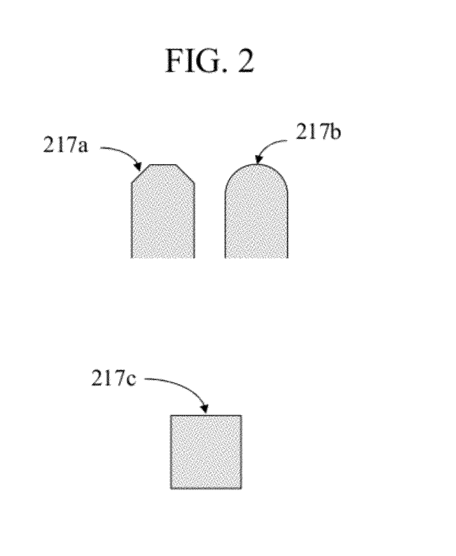

In a next step (130 in FIG. 1a), an edge 215 is formed on the coated glass article 210. In one embodiment, coated glass article 210 is controllably separated or divided into multiple pieces 211, 212 using those means known in the art, such as scribing and breaking, mechanical cutting, laser cutting, or the like. Coated glass article 210 can, for example, be separated into multiple pieces 211, 212 by first scribing by either mechanical means or with a CO₂ laser and then controllably breaking (i.e., breaking the glass into desired shapes and dimensions) the coated glass article 210 into multiple pieces 211, 212. The separation of the coated glass article 210 into multiple pieces 211, 212 of coated glass article 210 creates edges 215. In some embodiments, the edges 215 are machined or finished to obtain a finished edge 217 having a desired edge shape or profile (Step 140) using grinding, lapping, and polishing techniques that are known in the art, such as the use of metal bonded grinding wheels or pastes having various grit sizes. Examples of edge profiles that may be obtained are schematically shown in FIG. 2, and include a chamfered profile 217a, rounded (i.e., bullnose) profile 217b, and as-formed (i.e., scored and broken) profile 217c. Such finished edges 217 contain surface flaws (e.g., cracks, chips, etc.) of various shapes, sizes, and dimensions that are induced by the separation and machining processes. These surface flaws reduce the strength of the finished edge 217 and can lead to crack generation.

Edge formation after application of the protective polymeric coating 220 can result in fouling, clogging, or gumming up the grit of finishing tools. It is therefore useful in some embodiments to trim or remove protective coating 220 away from the portion of surface where an edge is to be formed so as to create an uncoated region adjacent to edge 215.

The strength of the edge can be increased by altering the geometry, or decreasing the size or dimensions, of flaws that are present in the edge 215. The energy required to propagate a flaw or crack is proportional to the radius of the crack tip and the length of the crack. In the next step (Step 150), the strength of the finished edge 217 is increased by reducing the dimensions and number of flaws on the finished edge 217. In one embodiment, the number of flaws is reduced by etching the finished edge 217 with an etchant. The etchant, in some embodiments, comprises at least one acid. The acid etches away microflaws and rounds out larger flaws, thus increasing the energy required to initiate and/or propagate a crack. In other embodiments, the finished edge 217 can be etched using other techniques known in the art, such as etching with a reactive gas or plasma etching.

In some embodiments, the etchant is an aqueous solution comprising hydrofluoric acid (HF) in which the HF concentration ranges from about 1% up to about 50% by volume and, in some embodiments, from 5 vol % up to 50 vol %. In some embodiments, the etchant further includes up to 50% by volume of a mineral acid such as sulfuric acid (H₂SO₄), hydrochloric acid (HCl), nitric acid (HNO₃), phosphoric acid (H₃PO₄), or the like. In some embodiments, the etchant is an aqueous solution comprising from about 5 vol % up to about 50 vol % nitric acid. In one non-limiting example, the etchant comprises 5 vol % HF and 5 vol % H₂SO₄. Alternatively, the etchant can comprise organic acids such as, but not limited to, acetic acid, formic acid, citric acid, or the like.

In other embodiments, the etchant is an aqueous solution comprising a mineral base such as, for example, an alkali metal hydroxide, and, optionally, a chelating agent such as EDTA or the like.

The etchant can further comprise at least one inorganic fluoride salt. In some embodiments, the inorganic fluoride salt is an inorganic bifluoride such as, but not limited to, ammonium bifluoride, sodium bifluoride, potassium bifluoride, combinations thereof, and the like. In other embodiments, the inorganic fluoride salt is one of ammonium fluoride, sodium fluoride, potassium fluoride, combinations thereof, or the like. In addition, the etchant can also include a water soluble wetting agent such as those known in the art, including glycols, (e.g., propylene glycol) glycerols, alcohols (e.g., isopropyl alcohol), glycerol, acetic acid, and the like, as well as those surfactants that are known in the art.

The etchant can be applied at room temperature (20-25° C.) to the edge. Alternatively, the etchant can be heated for the etching step to a temperature that is greater than room temperature. In one embodiment, the etchant is heated to temperature in a range from about 30° C. up to about 60° C.

The etchant can be applied to the edge of the glass article by dipping the edge in a bath comprising the etchant, spraying the edge with the etchant, or by other means known in the art. In all embodiments, the surfaces 205 of the glass article are protected by protective coating 220, which comprises those materials previously described herein.

The finished edge 217 is etched—i.e., exposed to the etchant—for a time that is sufficient to reduce or alter the flaw size or geometry to a desired level or size and/or achieve a desired edge strength. The finished edge 217, for example, may be exposed to an etchant for a time sufficient to remove all surface cracks/flaws that are visible under a light microscope at a selected magnification (e.g., 50-100×), or to achieve an average edge strength of at least 250 MPa and, in some embodiments, at least 300 MPa, based on four point horizontal bend testing. At the end of the etching time, the etched and strengthened edge 218 is typically rinsed with water to remove any residue or remaining particulate matter and then dried.

In those instances where the edge is etched by immersion in a bath, the etching step 150 can include agitation of the bath. Agitation can produce a more uniform etch by reducing the tendency of deposits (e.g., calcium- or sodium-containing deposits) to precipitate. Such deposits tend to protect portions of the edge from the etchant by decreasing the etch rate and typically result in rough areas on the etched surface 218. In a static bath, mass transfer can inhibit transport of fresh etchant to edge, especially in areas where the protective film overhangs the edge at a portion that receives maximum load. Agitation may also help circulate and homogenize the etch bath and thus allow improved etching of the edge.

In method 100 described hereinabove, the exposed portion of the edge is limited to that which has been machined or, in some embodiments, to a margin immediately adjacent to the edge 215 in which the protective coating 220 has been trimmed or removed from the portion of the surface of the glass article prior to edge formation. As previously described, trimming the protective coating prevents fouling, clogging, or gumming up tools that are used to finish the edge. All other surfaces remain covered by the protective coating or film while the edge is machined and etched. Formation of an edge prior to application of the protective coating or film could result in potential exposure of a portion of the flat surface. The exposed portion of the surface and any layers deposited thereon would consequently be etched and thus suffer optical distortions or damage. Formation of an edge prior to application of the protective coating 220 could also result in coverage of a portion of the edge by the protective coating 220. The presence of the protective coating 220 on the edge would prevent the etchant from reducing the dimensions and number of flaws underlying the covered portion, thus decreasing the ultimate part strength. By applying the protective coating 220 before creation of the edge 215, in accordance with method 100 described hereinabove, the pristine nature of surface 205 is preserved and the interface between the protective coating and the edge 215 is well-defined.

As described hereinabove, the optical clarity of the flat surface 205 could potentially be reduced by roughening of the surface due to etching. Such roughening is manifested by increased haze or diffuse scattering, or small variations in thickness of the glass article. By providing the protective coating 220 to the surfaces 205 of the glass 200 before forming the edge 215, optical clarity of these surfaces can be preserved and optical distortions minimized. In some embodiments, the haze of the surface 205, measured after etching of edge, varies by less than 10% from the initial haze value measured prior to application of the protective coating 220.

In those embodiments where glass article 200 includes at least one electrically active layer 250, protective coating 220 protects electrically active layer 250 from damage during edging, finishing, and etching strengthening operations.

Following etching step 150 and formation of etched and strengthened edge 218, the protective coating or film 220 can be removed from surface 205 (Step 160) by those means known in the art such as, but not limited to, dissolution of the film or coating by a solvent, melting, or by mechanical means such as peeling the protective coating away from surface 205. The glass article 230 having etched and strengthened edge 218 is then ready for use in the desired application.

In another embodiment of the method, schematically shown in FIG. 1b, edge 215 is formed on glass article 200 prior to application of protective coating or film 220. Method 400 includes a step of providing glass article 200 having surface 205 (Step 410), which is identical to step 110 of method 100, previously described hereinabove. Glass article 200 is, in some embodiments, a soda lime glass, an alkali aluminosilicate glass, or an alkali aluminoborosilicate glass, such as those described hereinabove. In some embodiments, surface 205 of glass article 200 is strengthened either chemically by ion exchange or thermally tempered, as previously described herein above. As previously described hereinabove, surface 205 can be a melt-derived surface or a polished surface. Glass article 200 can further include at least one electrically active layer 250 disposed on surface 205, as previously described hereinabove.

In a next step (420 in FIG. 1b) edge 215 is formed. In the embodiment shown in FIG. 1b, glass article is controllably separated or divided into multiple pieces 201, 202 using those means known in the art previously described hereinabove. After forming edge 215, at least a portion of surface 205 of the glass article is protected by applying a protective coating 220 to the selected portion of each of the surfaces 205 (Step 430 of method 400). As previously described hereinabove, protective coating 220 can comprise polymeric precursors that are applied to surface 205 and subsequently cured or dried after deposition, or an adhesive-backed, free standing polymeric film. In some embodiments, a portion 205a of surface 205 adjacent to edge 215 is not coated with protective coating 220, so as prevent fouling, clogging, or gumming up the grit of tools used to finish edge 215, as well as to prevent portions of protective coating from overhanging edge 215 and thus shielding flaws present in edge 215 from the etching/strengthening process.

In some embodiments, the edges 215 of coated glass article 203 are machined or finished to obtain a finished edge 217 (Step 440) having a desired edge shape or profile using grinding, lapping, and polishing techniques that are known in the art and described hereinabove. In the next step (Step 450), the strength of the finished edge 217 is increased by reducing the dimensions and number of flaws on the finished edge 217. In one embodiment, the number of flaws is reduced by etching the finished edge 217 with an etchant or using other etching techniques known in the art, as described hereinabove. Etchant compositions, etching conditions, and methods of applying etchants are identical to those previously described hereinabove.

Following etching step 450 and formation of etched and strengthened edge 218, the protective coating or film 220 can be removed from surface 205 (Step 460) by those means known in the art such as, but not limited to, dissolution of the film or coating by a solvent, melting, or by mechanical means such as peeling the protective coating away from surface 205. The glass article 230 having etched strengthened edge 218 is then ready for use in the desired application.

As previously described herein, optical clarity of surface 205 can be preserved and optical distortions minimized. In some embodiments, the haze of the surface 205, measured after etching of edge and removal of protective coating 220 (Steps 160, 460), varies by less than 10% from the initial haze value measured prior to application of the protective coating 220. In those embodiments where glass article 200 includes at least one electrically active layer 250, protective coating 220 protects electrically active layer 250 from damage incurred during finishing (Steps 140, 440) and etching/edge strengthening (Steps 150, 450).

In some embodiments, strengthened edge 218 has an average edge strength of at least 250 MPa, based on four point horizontal bend testing. In some embodiments, a portion of etched and strengthened edge 218 has a portion that is under a compressive stress. The potion extends from the surface of edge 218 to a depth of 15 μm. The compressive stress, in some embodiments, is at least 200 MPa. In one embodiment, the compressive stress is between 200 MPa and 800 MPa.

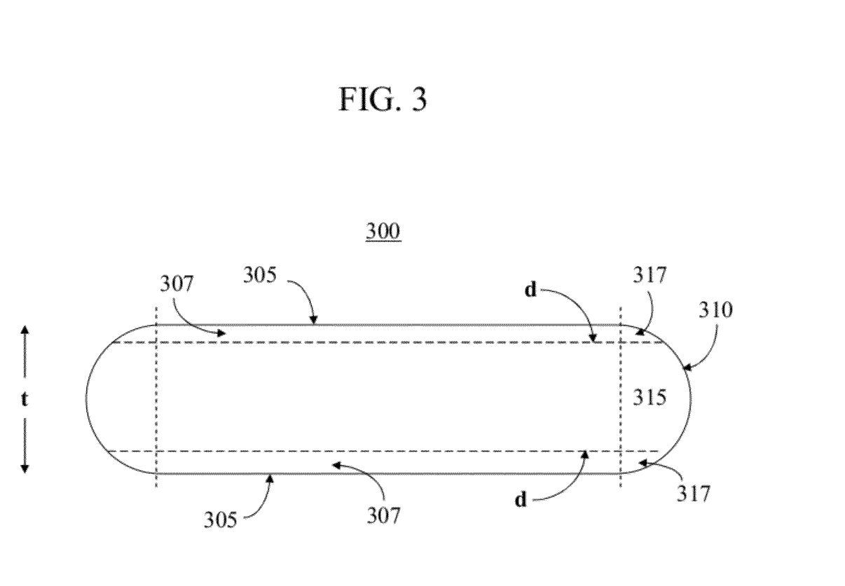

A glass article having an etched and strengthened edge is also provided. A cross-sectional view of the glass article is schematically shown in FIG. 3. Glass article 300 of thickness t has at least one surface 305 that is under compressive stress. Compressive stress layer 307 extends from surface 305 to a depth of layer d below surface 305. In some embodiments, the compressive stress in compressive stress layer 307 is at least 200 MPa and the depth of layer d is at least about 15 μm. In one embodiment, the compressive stress is in a range from about 200 MPa up to about 800 MPa, and the depth of layer d is in a range from about 15 μm up to about 60 μm. In those embodiments where the glass is a soda lime glass, the compressive stress is at least 500 MPa and the depth of layer is at least about 15 μm. In those embodiments where the glass is an alkali aluminosilicate glass or an alkali aluminoborosilicate glass, the compressive stress is at least about 600 MPa and the depth of layer is at least about 20 μm and, in some embodiments, in a range from about 20 μm up to about 35 μm.

Glass article 300 has at least one strengthened edge 310 adjacent to surface. Strengthened edge 310 is formed by first finishing the edge using those methods previously described herein, to obtain a predetermined edge profile (i.e., a profile that has been selected prior to finishing). The edge profile shown in FIG. 3 is a rounded or “bullnose” edge (217b in FIG. 2). The finished edge is then strengthened by reducing the dimensions of flaws that are present in the edge. Such flaws are typically introduced during formation or finishing of the edge. The dimensions of such flaws are reduced by applying an etchant to the finished edge, as previously described herein.

A portion 315 of strengthened edge 310 is not under compressive stress, whereas portions 317 are under compressive stress, due to exposure of compressive stress layer 307 during formation and finishing of the edge. Portion 317, in some embodiments, is at least 200 MPa. In one embodiment, the compressive stress of portion 317 is between 200 MPa and 800 MPa. In some embodiments, strengthened edge 310 has an average edge strength of at least 250 MPa and, in some embodiments, at least 300 MPa, as determined by four point horizontal bend testing.

In some embodiments, glass article 300 is a soda lime glass, an alkali aluminosilicate glass, or an alkali aluminoborosilicate glass, as described hereinabove. In one embodiment, the alkali aluminosilicate glass comprises alumina, at least one alkali metal and, in some embodiments, at least 50 mol %, SiO₂, in other embodiments, at least 58 mol %, and in still other embodiments, at least 60 mol % SiO₂, wherein the ratio

$$\frac{{Al}_{2} {O}_{3} ( mol \% ) + {B}_{2} {O}_{3} ( mol \% )}{\sum modifiers ( mol \% )} > 1 ,$$

where the modifiers are alkali metal oxides. This glass, in particular embodiments, comprises, consists essentially of, or consists of: 58-72 mol % SiO₂; 9-17 mol % Al₂O₃; 2-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum modifiers ( mol \% )} > 1 ,$$

where the modifiers are alkali metal oxides. In another embodiment, the alkali aluminosilicate glass comprises, consists essentially of, or consists of: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In yet another embodiment, the alkali aluminosilicate glass substrate comprises, consists essentially of, or consists of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm. As₂O₃; and less than 50 ppm Sb₂O₃; wherein 12 mol %≦Li₂O+Na₂O+K₂O≦20 mol % and 0 mol %≦MgO+CaO≦10 mol %.

The alkali aluminosilicate glass is, in some embodiments, substantially free of lithium, whereas in other embodiments, the alkali aluminosilicate glass is substantially free of at least one of arsenic, antimony, and barium. In some embodiments, the alkali aluminosilicate glass has a liquidus viscosity of at least 135 kpoise.

In some embodiments, surface 305 of glass article 300 is either chemically or thermally strengthened as previously described hereinabove. Such chemical strengthening can be accomplished by ion exchange. In this process, ions in the surface layer of the glass are replaced by—or exchanged with—larger ions having the same valence or oxidation state as the ions present in the glass. Ions in the surface layer of the glass and the larger ions are typically monovalent metal cations such as, but not limited to, Li⁺, Na⁺, K⁺, Rb⁺, Cs⁺, Ag⁺, Tl⁺, Cu⁺, and the like.

Glass article 300, in some embodiments, is down-drawn (e.g., fusion- or slot-drawn), as previously described herein. In some embodiments, compressive stress layer 307 is formed by ion exchange of glass article 300, as previously described herein.

Glass article 300 can further include electrically active layers, such as those comprising dielectric or conductive materials used in the manufacture of touch screens, panels, or displays, on at least one of surfaces 305. Glass article 300 can also be used as a touch screen, a touch panel, a display panel, a window, a display screen, a cover plate, a casing, or an enclosure for electronic communication and entertainment devices, such as games, cell phones, music, and DVD players and the like, as well as for information terminal devices, such as laptop computers and the like.

### EXAMPLES

The following examples illustrate the features and advantages of the methods and articles described herein, and are in no way intended to limit the disclosure or appended claims thereto.

Unless otherwise specified, the glass samples described in the following examples were alkali aluminosilicate glass samples having a nominal composition of 66 mol % SiO₂; 10 mol % Al₂O₃; 0.6 mol % B₂O₃; 14 mol % Na₂O; 2.5 mol % K₂O; 5.7 mol % MgO; and 0.2 mol % SnO₂. As specified in the various examples, the samples were either strengthened by ion exchange in a molten salt bath or did not undergo any such strengthening.

Samples were mechanically scribed or scribed using a CO₂ laser and then broken into sizes that were appropriate for testing. For example, the samples were broken into 44 mm×60 mm coupons for modulus of rupture (MOR) four point horizontal bend measurements.

Unless otherwise specified, a protective adhesive-backed low density polyethylene (LDPE)-based film was applied to the surfaces of each sample after scribing and breaking. Four types of LDPE-based adhesive-backed films were used: type A, having a peel strength of 250 g; type B, having a peel strength of 350 g; type C, having a peel strength of 350 g; and type D, having a peel strength of 550 g. As used herein, the term “peel strength” refers to the average load per unit width required to separate the film from the surface of the glass sample. Unless otherwise specified, the edges of the samples were mechanically ground and contoured to either a bullnose or a chamfer after application of the protective film. Unless otherwise specified, the ground and contoured edge of each sample was then etched in a solution containing 5 vol % HF and 5 vol % HCl for a period ranging from 1 minute to 128 minutes, as described in the various examples.

Edge strengths of all samples were measured based on an edge break using 4-point horizontal bend testing, and the data were plotted using Weibull plots in which the percent probability of fracture is plotted as a function of strength.

### 1. Ion Exchange Effects

In order to determine the effect of ion exchange on edge performance, the edge strength of samples having surfaces that were strengthened by ion exchange were evaluated. Compressive stress (CS) and the depth of the compressive layer (“depth of layer” or DOL) were measured a surface stress meter. In one group (group a), samples had a “low” CS of approximately 625 MPa and a DOL of approximately 36 μm. In the second group (group b), samples had a “standard” compressive stress of about 750 MPa and a DOL of about 30 μm. Following ion exchange, the strengthened surfaces were coated with a type A protective polymeric layer. The edges of the samples were then machined (i.e., ground) to produce a desired edge profile or shape and then etched in a solution containing 5 vol % HF and 5 vol % HCl for 32 minutes.

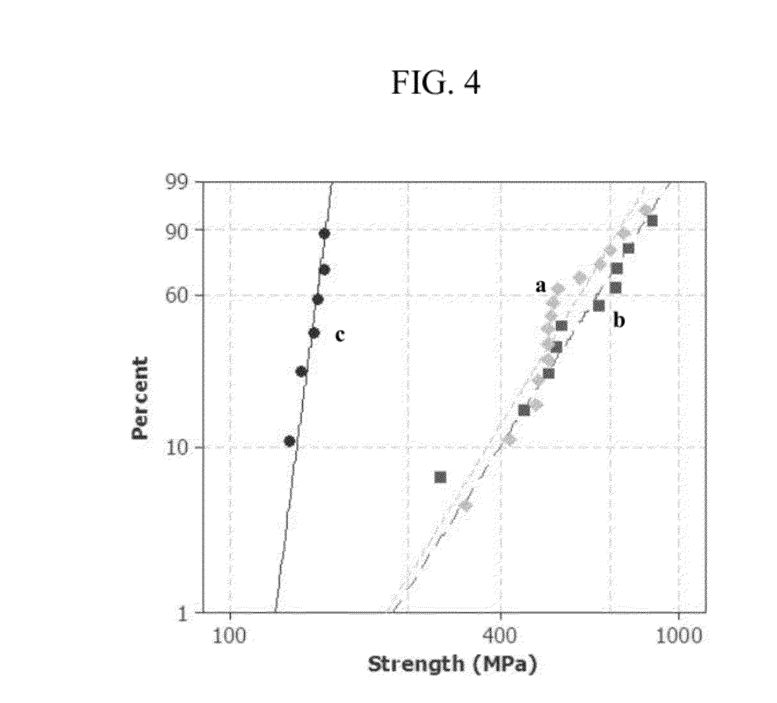

The Weibull edge strength distributions of the group a and group b samples and a group of coated, unetched control samples (group c) are plotted in FIG. 4. The figure shows that the entire distribution of edge strengths has shifted and that even the weakest acid-etched edge is stronger than the unetched edge. In addition, the data shown in FIG. 4 indicate that differences in CS and DOL between groups a and b produced no discernable difference in edge strength performance.

### 2. Film Effects

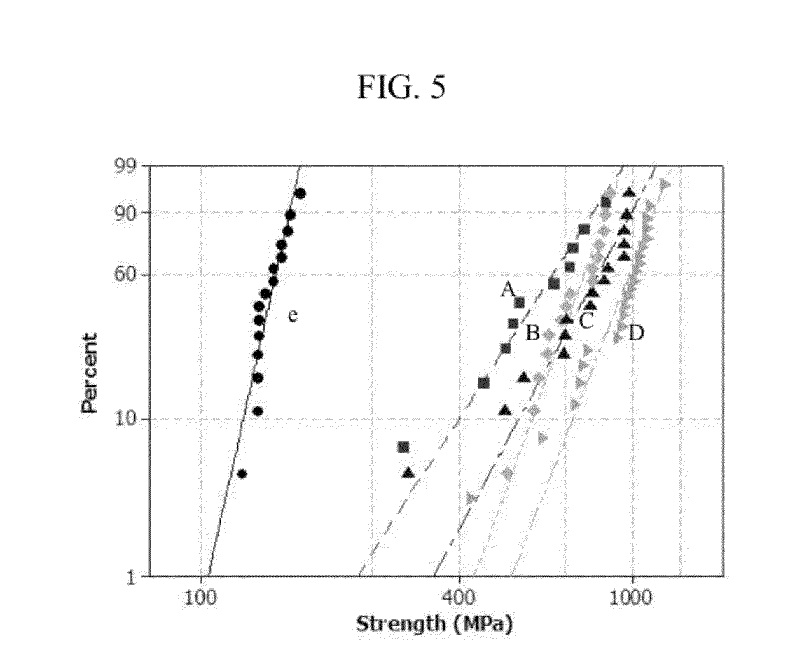

The effect of protecting the surfaces of the glass samples during acid etching of the sample edges was investigated. Type A, B, C, and D adhesive-backed LDPE-based films, previously described hereinabove, were applied to the surfaces of glass samples that had been ion exchanged. The labeling of sample groups corresponds to the film type applied to each group (e.g., type A film was applied to samples in group A). The edges of the samples were then etched in a solution containing 5 vol % HF and 5 vol % HCl for 32 minutes. Although the type B and C films were reported to have the same peel strength, the type C films appeared to adhere more strongly to the glass than the type B films. The Weibull edge strength distributions obtained for samples A-D and an uncoated control sample (e) are plotted in FIG. 5. The edge strength performance obtained for the samples coated with different LDPE-based protective films (A, B, C, and D in FIG. 5) improved with increasing peel strength of the films—i.e., group D>group C>group B>group A.

### 3. Edging Effects

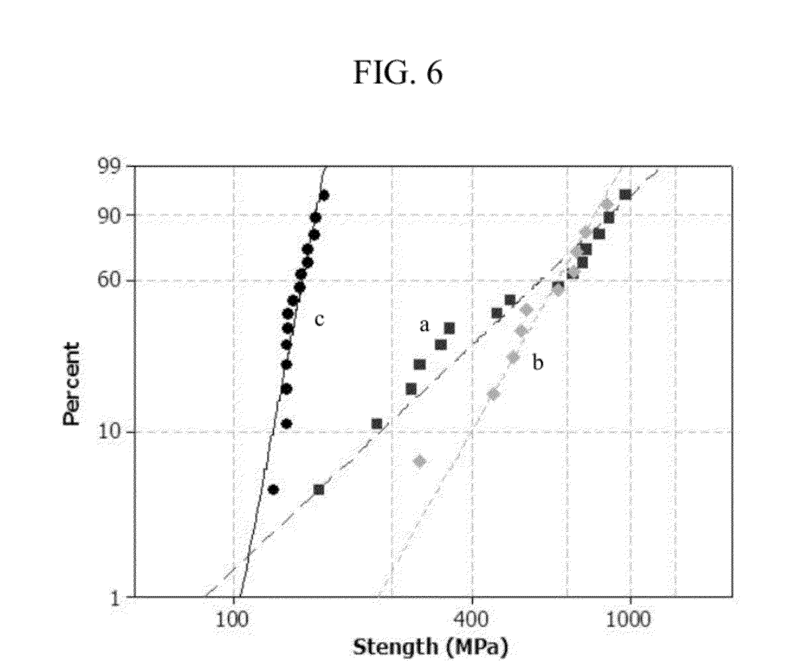

The edge machining or “edging” process is the greatest source of flaw introduction. Several aspects of the edging process were therefore evaluated. The effect of the order in which the steps of applying the protective film and edging are performed was first studied. Applying the protective film to the samples after edge machining risked additional handling of the samples and introducing edge damage during the coating process, whereas edging the glass samples after film application could potentially foul or “gum up” the edging equipment with the film material. The fouling effects on edging equipment can be minimized by trimming the protective film close to the edges during the film application process. By trimming the protective film close to the edges, the majority of edge flaws was introduced through the edging process itself and could therefore be later removed by etching. All edges of the samples were finished/edged to a rounded or “bullnose” profile (e.g., 217a in FIG. 2) and then etched in a solution containing 5 vol % HF and 5 vol % HCl for 32 minutes. Protective type A LDPE-based films were applied either (a) before edging or (b) after edging. FIG. 6 is a plot of Weibull edge strength distributions for samples coated with a protective type A LDPE film before edging (a); after edging (b); and unetched, uncoated control samples (c). The edge strength distributions shown in FIG. 6 illustrate the improvement in edge strength observed when the protective film is applied before edging rather than after edging.

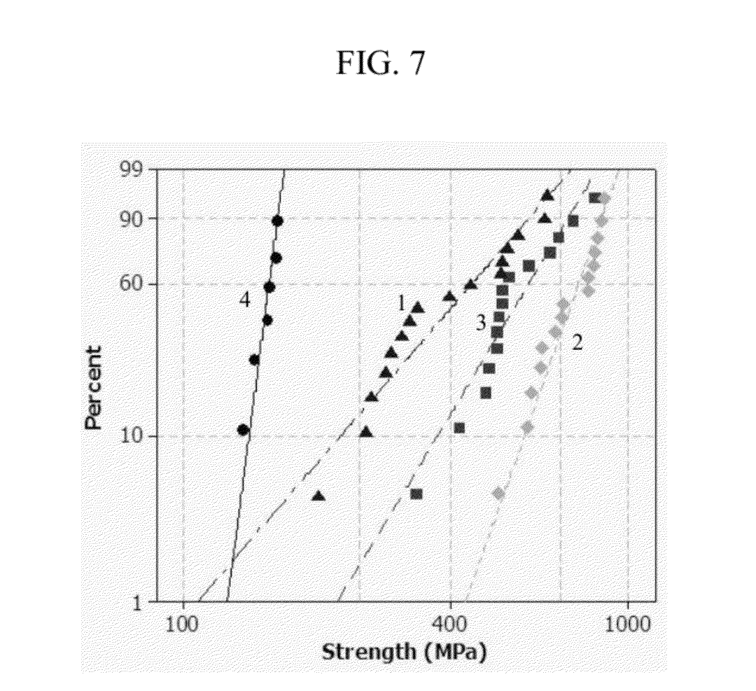

The effect of different edging techniques was also studied. Surfaces of all samples were coated with protective, LDPE-based, adhesive-backed films of either type A or type B prior to edging. A first group of glass samples was coated with type B LDPE-based film and then edged to a “crude” bullnose profile using a 270/320 grit metal bonded wheel at rotating at 4500 rpm, and feed rate of 15 inches per minute (ipm) with a 0.003 inch depth of cut. A second group of glass samples was coated with type B LDPE-based film and then edged to a “standard” bullnose profile using a 400 grit metal bonded wheel rotating at 4500 rpm and 15 ipm feed rate with a 0.003 inch depth of cut. A third group of glass samples was coated with type A LDPE-based film and then edged to a “standard” bullnose profile using a 400 grit metal bonded wheel rotating at 4500 rpm and 15 ipm feed rate with a 0.003 inch depth of cut. The edges of the samples were etched for 32 minutes with an etching solution containing 5 vol % HF and 5 vol % HCl. Edge strengths of the etched edges were then measured using four-point horizontal bend testing. Weibull edge strength distributions for: 1) samples edged to a “crude” bullnose profile and coated with a type B protective film; 2) samples edged to a “standard” bullnose profile and coated with a type B protective film; 3) samples edged to a “standard” bullnose profile and coated with a type A protective film; and 4) control samples edged to a “standard” bullnose profile that was uncoated and unetched are shown in FIG. 7. The Weibull slopes of the etched samples reflect the presence of initial coarse and fine fractures that are caused by the different edging processes and support the premise that the finer the initial flaws in the edge, the stronger the edge is after etching.

### 4. Etching Effects

The effects of etching time and agitation of the etch bath were investigated. Glass samples were ion exchanged to produce surface layers having either “low” compressive stress (approximately 625 MPa with about 36 μm DOL) or “standard” compressive stress (approximately 750 MPa with about 30 μm DOL). Each ion exchanged sample was coated with a type A LDPE protective film and then edged to a “standard” bullnose profile using a 400 grit metal bonded wheel rotating at 4500 rpm and 15 ipm feed rate with a 0.003 inch depth of cut. The edged samples were etched with an etching solution containing 5 vol % HF and 5 vol % HCl for times ranging from 0 minutes up to 128 minutes.

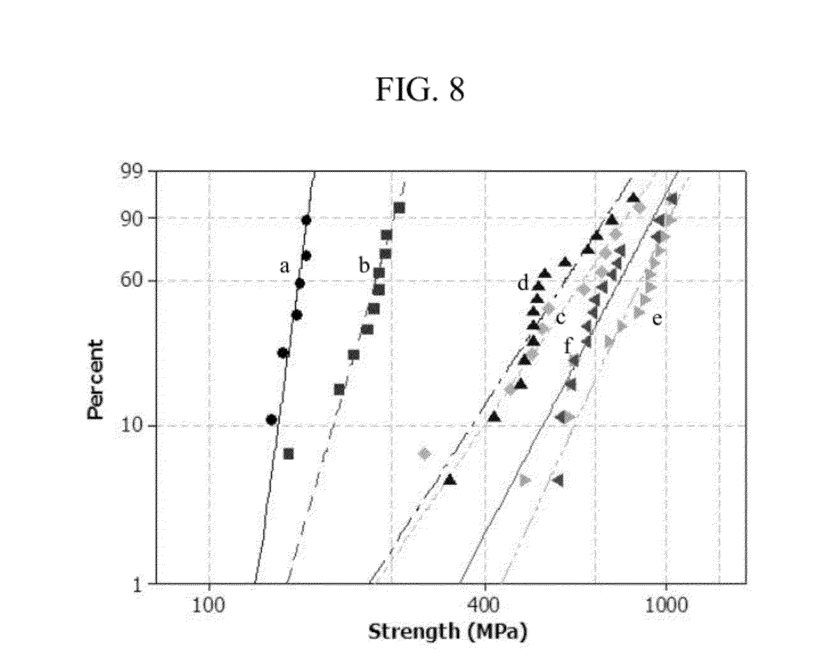

Edge strengths were measured using 4-point horizontal bend testing. FIG. 8 is a plot of Weibull edge strength distributions for edges: a) samples having “standard” compressive stress, etched 0 minutes; b) samples having “standard” compressive stress, etched 8 minutes; c) samples having “standard” compressive stress, etched 32 minutes; d) samples having “low” compressive stress, etched 32 minutes; e) samples having “low” compressive stress, etched 64 minutes; and f) samples having “standard” compressive stress, etched 128 minutes.

The results plotted in FIG. 8 indicate that not all of the largest flaws have either been eliminated or reduced in size even after 128 minutes of etching. However, a sufficient number of such flaws are eliminated or reduced in size to increase the average strength nearly four-fold, from about 250 MPa to about 900 MPa. The majority of the sample populations etched for 32 minutes (sample groups c and d in FIG. 8) had edge strengths greater than 250 MPa. Etch times of either 64 or 128 minutes can be used to increase the whole population above the target edge strength.

The effect of etching the glass samples in either a static bath or an agitated bath was also investigated. Agitation may help circulate and homogenize the acid etch bath and thus allow improved etching of the edge. In a static bath, mass transfer can inhibit transport of fresh etchant to edge, especially in areas where the protective film overhangs the edge at a portion that receives the maximum load during horizontal 4-point bend testing.

Glass samples were coated with a type B LDPE protective film and then edged to a “standard” bullnose profile using a 400 grit metal bonded wheel rotating at 4500 rpm and 15 ipm feed rate with a 0.003 inch depth of cut. The edged samples were etched with an etching solution containing 5 vol % HF and 5 vol % HCl for either 32 minutes or 128 minutes in either a static bath or an agitated bath.

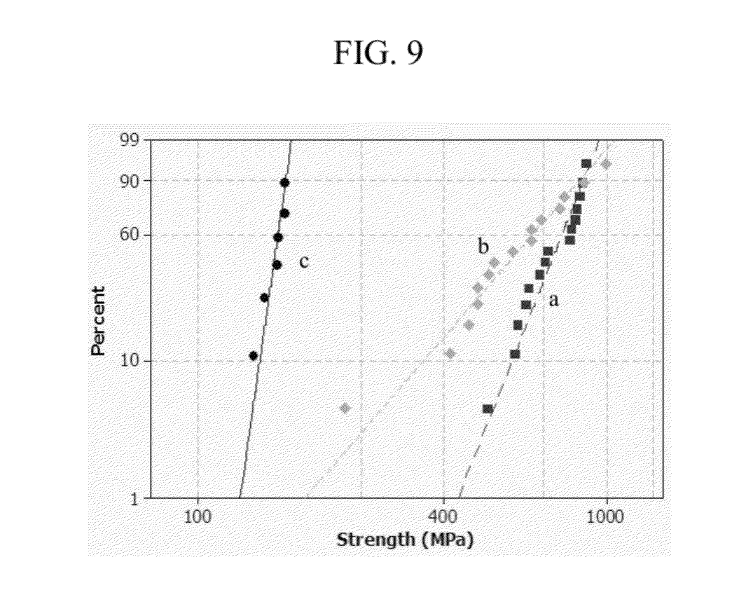

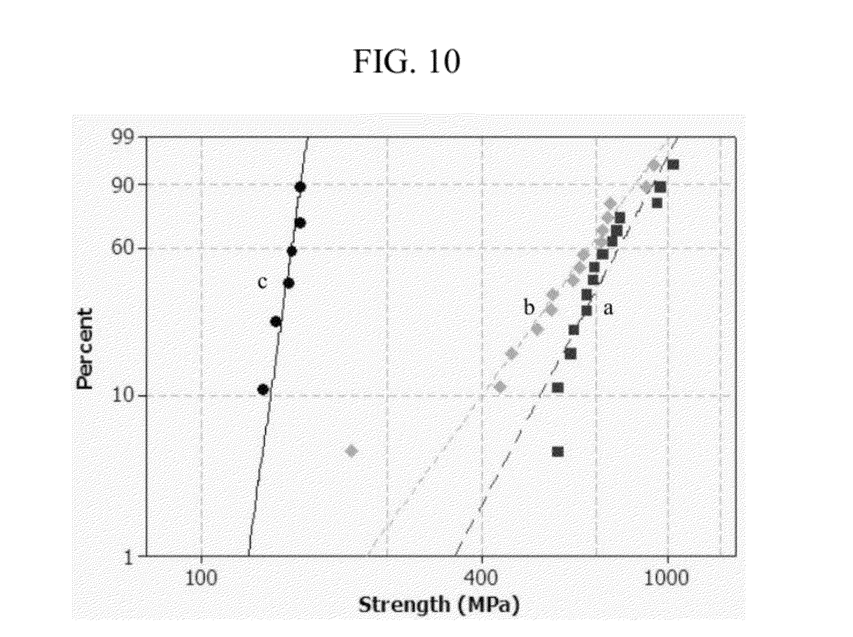

FIGS. 9 and 10 are plots of Weibull edge strength distributions for edges etched for 32 and 128 minutes, respectively, for: a) samples etched in a static bath; b) samples etched in an agitated bath; and c) unetched control samples. Based on the results shown in FIGS. 9 and 10, agitation of the etchant bath does not improve edge strength.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A method of strengthening an edge of a glass article, the method comprising the steps of:
a. providing the glass article, the glass article having a surface;
b. protecting at least a portion of the surface; and
c. reducing dimensions of each of a plurality of flaws on an edge of the glass article, the edge being adjacent to the surface, wherein reducing the dimensions of the flaws strengthens the edge.

2. The method of claim 1, wherein the step of protecting at least a portion of the surface comprises applying a polymeric coating to the portion of the surface.

3. The method of claim 2, wherein the step of applying the polymeric coating to at least a portion of the surface comprises applying a polymeric precursor to at least a portion of the surface by at least one of spray-coating, spin-coating, and dip-coating.

4. The method of claim 2, wherein the polymeric coating comprises at least one of polytetrafluoroethylene, polymethylmethacrylate, high density polyethylene, low density polyethylene, polyvinyl chloride, polymethyl pentene acrylonitrile/butadiene/styrenes, a polycarbonate, a polypropylenes, and a polystyrene.

5. The method of claim 2, wherein the polymeric coating is a polymeric film having an adhesive disposed on a surface, and wherein the polymeric film is applied to at least a portion of the surface of the glass article by contacting the adhesive with the portion of the surface of the glass article.

6. The method of claim 1, wherein the step of reducing the dimension of each of the plurality of flaws comprises etching the edge with an etchant.

7. The method of claim 6, wherein the etchant comprises 1-50 vol % of hydrofluoric acid and at least one of a mineral acid and an organic acid.

8. The method of claim 1, wherein the glass article comprises one of a soda lime glass, an alkali aluminosilicate glass and an alkali aluminoborosilicate glass.

9. The method of claim 8, wherein the alkali aluminoborosilicate glass comprises: 58-72 mol % SiO₂; 9-17 mol % Al₂O₃; 2-12 mol % B₂O₃; 8-16 mol % Na₂O; and 0-4 mol % K₂O, wherein the ratio
$$\frac{{Al}_{2} {O}_{3} ( mol \% ) + {B}_{2} {O}_{3} ( mol \% )}{\sum modifiers ( mol \% )} > 1 ,$$
where the modifiers comprise alkali metal oxides.

10. The method of claim 8, wherein the alkali aluminosilicate glass comprises: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO.

11. The method of claim 8, wherein the alkali aluminosilicate glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

12. The method of claim 1, wherein the surface has a compressive stress layer extending to a depth below the surface.

13. The method of claim 1, wherein the step of providing the glass article comprises fusion-drawing the glass article.

14. The method of claim 1, wherein the surface is a melt-derived surface.

15. The method of claim 1, wherein the surface is a polished surface, and wherein the polished surface is under a compressive stress of at least 200 MPa and has flaws averaging less than 10 μm in size.

16. The method of claim 1, further comprising forming the edge.

17. The method of claim 16, wherein the step of forming the edge precedes the step of protecting the surface.

18. The method of claim 16, wherein the step of forming the edge follows the step of protecting the surface.

19. The method of claim 16, wherein the step of forming the edge comprises scribing the surface and breaking the glass article to form the edge.

20. The method of claim 16, wherein the step of forming the edge comprises cutting the glass article to form the edge.

21. The method of claim 16, wherein the step of forming the edge comprises:
a. selecting an edge shape; and
b. machining the edge to obtain the edge shape, wherein machining the edge comprises at least one of grinding, lapping, and polishing the edge.

22. The method of claim 21, wherein the edge shape is one of a bullnose and a chamfered edge.

23. The method of claim 1, wherein the strengthened edge has an average edge strength of at least 250 MPa.

24. The method of claim 1, wherein the step of providing the glass article comprises providing a glass article having a surface, the surface having a compressive stress layer extending from the surface to a depth below the surface.

25. The method of claim 24, wherein the compressive stress layer is formed by ion exchange, and has a compressive stress of at least 500 MPa.

26. The method of claim 1, wherein the surface has a first haze value before the step of reducing the dimensions of each of the flaws and a second haze value after the step of reducing each of the flaws, and wherein the second haze value varies by less than 10% from the first haze value.

27. The method of claim 1, wherein the glass article having the strengthened edge is one of a touch screen, a touch panel, a display panel, a window, a display screen, a cover plate, a casing, and an enclosure for one of an electronic communication device, an electronic entertainment device, and an information terminal device.

28. A glass article, the glass article having a surface under compressive stress and an edge adjacent to the surface, wherein the edge is machined and has a predetermined profile, wherein at least a portion of the edge is not under compressive stress, and wherein the edge is etched and has an average edge strength of at least 250 MPa.

29. The glass article of claim 28, wherein the glass article comprises one of a soda lime glass, an alkali aluminosilicate glass and an alkali aluminoborosilicate glass.

30. The glass article of claim 29, wherein the alkali aluminoborosilicate glass comprises: 58-72 mol % SiO₂; 9-17 mol % Al₂O₃; 2-12 mol % B₂O₃; 8-16 mol % Na₂O; and 0-4 mol % K₂O, wherein the ratio
$$\frac{{Al}_{2} {O}_{3} ( mol \% ) + {B}_{2} {O}_{3} ( mol \% )}{\sum modifiers ( mol \% )} > 1 ,$$
where the modifiers comprise alkali metal oxides.

31. The glass article of claim 29, wherein the alkali aluminosilicate glass comprises: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO.

32. The glass article of claim 29, wherein the alkali aluminosilicate glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

33. The glass article of claim 29, wherein the glass article is one of a touch screen, a touch panel, a display panel, a window, a display screen, a cover plate, a casing, and an enclosure for one of an electronic communication device, an electronic entertainment device, and an information terminal device.
